(19) United States
(12) Patent Application Publication
(10) Pub. No.: US 2012/0248765 A1
(43) Pub. Date: Oct. 4, 2012

(54) UNIVERSAL PIPE CONNECTION AND METHOD

(76) Inventor: JOHN WATTS, AUSTIN, TX (US)

(21) Appl. No.: 13/434,443

(22) Filed: Mar. 29, 2012

Related U.S. Application Data
(60) Provisional application No. 61/470,348, filed on Mar. 31, 2011.

(51) Int. Cl. F16L 15/06; F16L 25/00; F16L 21/00; F16L 15/00; B21D 11/00; B21D 9/00

(52) U.S. Cl. 285/332; 72/370.1; 72/370.06; 285/399; 285/390

(57) ABSTRACT

A minimum diameter full-strength pipe connection of low cost is disclosed for all services.

Priority is claimed on Provisional Patent Application No. 61/470,348 filed on Mar. 31, 2011 by John D. Watts. This invention is an improvement on threaded pipe connections for use in any and all services but it is particularly useful on oil field pipe. Incorporated herein by reference are patents: U.S. Pat. Nos. 5,427,418; 5,143,411; 6,578,880; PCT/US2007/001159.

### TECHNICAL FIELD

### Background of the Invention

Most pipe connections in use today are externally threaded pipe ends screwed into internally threaded couplings to convey low pressure water and gas in homes, but they are not suitable for most industrial applications that require additional features to reduce both leakage and cost; a small outer diameter to allow more compact positioning of pipe strings; higher assembly torque to prevent loosening in service; ability to seal against high pressure liquids and gases; and high mechanical strengths in tension, compression and bending. Perhaps the greatest usage of high performance pipe connections has been in the drilling and production of oil and gas Wells, within which, space is severely limited and the fluid pressures and fluid characteristics are hostile and frequently unknown. Integral joint (IJ) pipe connections typically have efficiencies no higher than 75% so for higher efficiency, a coupling or an upset is required, but both solutions increase costs and reduce clearances. Pipe couplings incur the cost of larger diameter special material and also the machining of twice as many threads per connection and upset machines for large size pipes are non-existent because the demand volume for upset joints on large pipe does not justify their purchase or maintenance. Existing connections with expanded boxes have weaknesses that prevent them from being high strength, such as: box walls being weaker at the last engaged thread than the pipe body wall; thread forms that loosen and leak such as API 8Round and Buttress threads. Pipe mill tolerances on diameters are too large for many pins to be formed on pipe-ends without precisely re-sizing the ends before threading, however, because the pipe joint is handled twice and clamped twice in a vise during conventional end-forming, added costs may further prohibit its use.

Virtually all existing tapered pipe threads have geometric weaknesses that cause them to gall during assembly and then leak, in addition to the weaknesses explained and solved in my earlier patent '418, which has prompted many manufacturers to add “pin-nose-seals” on their pins that inadvertently, created other weaknesses such as susceptibly to mechanical damage, leakage and lower strengths, in compression and bending. However, problems are not solved by adding un-needed features. Threads specifications such as API 5B 8Round and Buttress threads, have form deficiencies that have not been corrected since their adoption in 1939, and there are numerous deficiencies the API 5B Committee is still not aware of such as: The crest radius on all 5B thread forms allows the mating threads to contact each other at extreme pressure angles and cause galling, which in turn can cause leakage, loosening or lock-up, that may also prevent the possibility of proper makeup and/or subsequent disassembly.

As a pin is being lowered into a mating box, the pin thread contacts the box thread in varying ways, depending on the relative rotational positions of the two threads when they first contact. If the start positions of the two threads face each other when stabbed there may be adequate stab flank area contact so the threads may tighten smoothly without damage, but if the start positions are within one-half turn past each other, the threads may gall and preclude proper assembly, the contact angle between box and pin thread crests being at an extreme pressure angle, causing the pin threads to wedge down between the box threads during rotation such that they generate extreme interface pressure and gall each other. In an attempt to avoid that, the usual assembly procedure begins with low force left-hand rotation until the pin “jumps” down into the box one thread, which if rotation is quickly stopped, signals the pin to be in best start position rotationally. However, such a procedure may exert extreme pressures between the thread crests adjacent the thread starts immediately prior to the jump, which may initiate galling on those first threads if the weight of the joint(s) then being stabbed is enough to cause galling.

Common problems with pipe connections are over-tightening, and under-tightening which over-stress the box and pin circumferentially or leave the connection loose and leaking. If pipe ends are upset, then a shoulder may be formed on the pin to engage the box face and thereby assure proper makeup position, but at increased costs. Likewise, helically wedging threads per patent '880 assured proper makeup without overstress.

For purposes of this application, the following definitions apply. Critical Angle=The smallest angle that can be formed between a thread crest and the axis that will not cause the threads to damage each other while the pin is being stabbed into the box under normal service conditions, the critical angle being near the angle of friction between the mating threads; Box=internally threaded tubular member; Pin=externally threaded tubular member; Axis=the rotational axis of the pin or box; OD=outermost diameter; ID=innermost diameter; full strength=A strength substantially equal to the pipe body strength; Taper=Diameter change per unit length; Pin Contour=A pipe end plastically shaped to be later formed with a pin thread; Box Contour=A pipe end plastically shaped to be later formed with a box thread; Threads may be formed by any suitable method; Box neck=the box wall at the smallest diameter of thread engagement; Pin neck=the pin wall at the largest diameter of thread engagement.

### DISCLOSURE OF THE INVENTION

The Present Invention teaches elimination of problems and limitations of prior art and it also supplements teachings of my patents '411, '880, '1154, that teach the only full strength connection having an expanded box known by applicant. The present invention provides a low cost, high strength connection for both small and large diameter pipe, having optimum internal and external radial clearance, and methods to make it.

Patent '411 teaches in columns 6 and 7 the forming of cylindrical contours on pipe ends to be threaded for pin and box but does not specify contour diameters or thread features necessary for a high strength pipe connection nor thread form features to preclude galling. '1154 teaches on pages 7, 10, 11, FIG. 5 and in claims 3, 5, 24, 25, 26 & 27, an inner annular surface within an expanded box formed around a pipe bore on a diameter large enough, for a substantial pin end face width to fit radially between that annular surface and the required pipe bore, to thereby provide selectively, a connection strength between 75 and 100% strength, but it does not provide for the least box OD. Patent '880 teaches an open wedge type thread and PCT '154 teaches an improved thread fit that may be used with features of the present invention.

The present invention teaches even simpler box and pin configurations and how to form them before threading: To allow engaged box and pin threads to extend substantially from the box face to the box ID and from the pin face to the pin OD; Forming a cylindrical box by forcing an expansion ring into the end of a pipe joint to expand the box contour progressively, to be larger in diameter than the pipe body; Forcing a reducing ring around the other end of the pipe joint to progressively reduce the pin end contour prior to machining the threads without need for a vise to hold the pipe, because the forming force at one end opposes the forming force at the other end; Use of forming rings that move along the formed pipe lengths to size cylindrical boxes and pins, instead of using tapered mandrels to produce conical surfaces for threading; Reducing the force required to form cylindrical contours in combination with other thread features; and eliminate the critical axial positioning of the formed lengths before threading the ends, as is required when conical ends are formed.

Ideally for API casing and tubing: (1) the pin OD is plastically sized substantially 2.5% smaller than the pipe body OD without requiring substantial metal removal, to provide a pin ID only large enough to pass the standard API drift bar; (2) The engaged thread length when assembled, extends from the pin OD to the box ID such that the pin neck and the box neck may be full strength; (3) The thread taper, the thread flank width, the thread length and the thread axial pitch are dimensioned such that the engaged load flank area may substantially equal the pipe cross sectional area; The box ID substantially equals, the pin OD plus twice the thread depth, minus the taper multiplied by the engaged thread length; (5) The box OD substantially equals the box ID, plus twice the pipe wall thickness; (6) The assembled box and pin comprise a connection strength selectively, between 75 and 100%; the connection having a least box OD and a least cost; (7) the finish machining required being substantially only to form faces threads.

The box thread crest diameter at face substantially equals the pin OD so box threads can mesh with all run-out threads on the pin neck, and the pin thread crest diameter at the face substantially equals the box ID, so the pin threads can mesh with all run-out threads within the box. Thus, engaged mating threads may extend from the pin OD to the box ID and thereby provide up to full strength thread connections. Any suitable thread form may be used that is sufficient for the service intended but for maximum advantages, thread forms disclosed in my references above and herein, are preferred.

Pipe end forming with tapers has been done by clamping a pipe joint near one end in a vise and forcing a tapered mandrel into the pipe end so as to form an expanded tapered box within one end and then forcing a tapered cup around the other end to form a surface to thread a pin on the other end. However, the present invention teaches forming both ends simultaneously, using thrust from only one source, as follows: A forming ring sized to reduce the pill end to a predetermined cylindrical pin OD, is mounted in position to resist axial force from the pipe joint being formed; a pipe support member may be positioned to support the pipe joint; a forming ring sized to expand the box contour ID to a predetermined size is mounted to provide sufficient axial force resistance to form the pipe ends; the axial force being transmitted through the pipe joint to force the other end into the pin forming ring. To prevent an excess formed length of the pin contour, the pin forming ring may have a shoulder positioned behind it to stop movement of the pipe end into the ring when the desired length for the pin contour has been formed. To permit easy retraction of the forming rings from the pipe ends with minimum wear, the rings may be segmented and held in place against the pipe during the forming stroke and then released as the return stoke begins, so as to reduce pressure from between the ring and the formed surface. Part or all of the forming process may be automated using such as powered pipe support and hold down rollers and conventional sloped rails to convey the pipe to and from the forming station, with programmed motorized units moving the pipe as required.

To form pipe ends in the field or in a pipe storage yard in a more cost-effective manner, or to form small quantities of large size pipe, the forming rings as described above may be provided with portable actuation modules which are mounted on the ends of a pipe joint even while stacked in a pipe storage yard, to reduce pipe handling costs. The box module may comprise a support nose that slides within the pipe to position and support the module, and the pin module may comprise a nose that slides around the pipe end to position and support that module after which, the units are forced together by any suitable force. Such formed pipe ends may then be threaded or may be used for such as bell/spigot joints or as slip-weld joints. Ends are typically cold formed and then, depending on the pipe material, stress relieved to offset the Bauschinger effects if need be. The box expansion ring may be replaced with a conventional tapered mandrel to form a tapered box end and/or the pin forming ring may be replaced with a conventional tapered cup to form a tapered pin end simultaneously, and other variations may be employed without departing from the spirit of my invention. One pipe end only may be formed using only one such module, the end force required to form the pipe end being developed by other means.

A novel pipe connection that may be formed by this or another method is also taught that comprises properly sized cylindrical box and pin contours; tapered threads then being formed within the box from the box face substantially to the box ID and mating threads being formed on the pin substantially from the pin face to the pin OD such that a connection strength between 75% and 100% selectively, is provided that has a minimum box OD, a maximum pin ID and a minimum cost. Ideally, the pin ID should be reduced to the minimum allowable diameter for the intended service which in turn, allows for a minimum box OD, the contours being sized more precisely than pipe mill tolerances allow, which reduces machining time and cost to thread the ends. However, for other services such as for drill-pipe or for a fish-string or for expandable casing, the pin ID may formed even smaller. A thread taper greater than the conventional pipe thread taper of ¾″ per foot is preferred so as to prevent excessive thread length and to improve stab characteristics. Ideally, a 0.14 thread taper combined with a flank width equal to one-fourth of the thread pitch, provides an engaged flank area that is substantially equal to the pipe cross-sectional area without excess thread length so as to provide a simple low cost, full-strength pipe connection, but other tapers and flank widths may be used without departing from the spirit of the invention.

Because the crest radii of thread forms such as API 5B 8Round extend from the crest to both the load flank and the stab flank, a common portion of the crest radii of each thread near the axis exists that initiate contact between the mating threads at an extreme pressure angle when the pin is being stabbed into the box, that can cause galling. PCT '154 teaches in FIG. 7, a way to eliminate scoring and galling during assembly of threads having round crests such as API 5B round threads, and the present invention teaches an improvement of that feature, the contouring and dimensioning of the thread forms such that no critical angle can exist between the box and pin thread crests while the pin is being stabbed into the box, under normal service conditions. Thus, instead of the load flank crest arc extending continuously from the load flank to the stab flank of a round thread crest, or extending from either flank of a buttress form thread to the straight crest, the present invention teaches termination the crest arc before the angle between the arc and the axis becomes as small as the critical angle. Variations such as any combination of bevels that preclude critical angles may replace crest arcs without departing from the spirit of my invention. The critical angle approximates the angle of friction between the threads but it may vary from one pipe material to another, so to simplify thread tooling, it may be advisable to use the largest critical angle that exists in a family of threads, found by experiment.

### BRIEF DESCRIPTION OF DRAWINGS

FIG. 1: Depicts a half-section of a pipe joint with both ends formed in accord with the invention.

FIG. 2: Depicts a quarter section of an assembled threaded connection of the invention.

FIG. 3: Depicts a box end formed in accord with the invention, mated with a pipe size pin.

FIG. 4: Depicts a pin end formed in accord with the invention, mated with a pipe size box.

FIG. 5: Depicts a slip-weld joint formed in accord with the invention.

FIG. 6: Depicts a box forming module.

FIG. 7: Depicts a pin forming module.

FIG. 8: Depicts a work station that forms the box and pin ends simultaneously.

FIG. 9: Depicts forming modules for use in the field.

FIG. 10: Depicts an API 5B buttress thread form.

FIG. 11. Depicts an API 5B round thread form.

### MODES FOR PRACTICING THE INVENTION

In FIG. 1, an end of pipe joint (1) is shown expanded to form cylindrical box contour OD (12) to later be formed with box thread (13), the thread extending from box face (14) to thread run-out (15) within box ID (10) so as to provide a box as strong as the pipe body. The other end of the joint may be reduced in diameter to form pin contour (16) to be formed with mating pin threads (17) extending from pin face (18) to thread run-out (19) on pin OD (9) so as to provide a pin as strong as the pipe body. ID (10) and OD (12) of the box are preferably sized precise plastically such that they need not be resized before thread (13) is formed. Pin OD (9) and ID (7) of pin contour (16) are preferably sized precise plastically also, such that ot need not be resized before pin thread (17) is formed. The thread length and thread taper is dimensioned to provide the engaged flank area required for a connection strength that is selectively, 70% to 100% of full strength. I have found that a thread flank width equal to one-fourth of the axial thread pitch in combination with a thread taper of 0.14 efficiently provides a full strength connection having excellent assembly characteristics, but any combination of thread form and taper that provides the desired engaged flank area may be used without departing from the spirit of the invention.

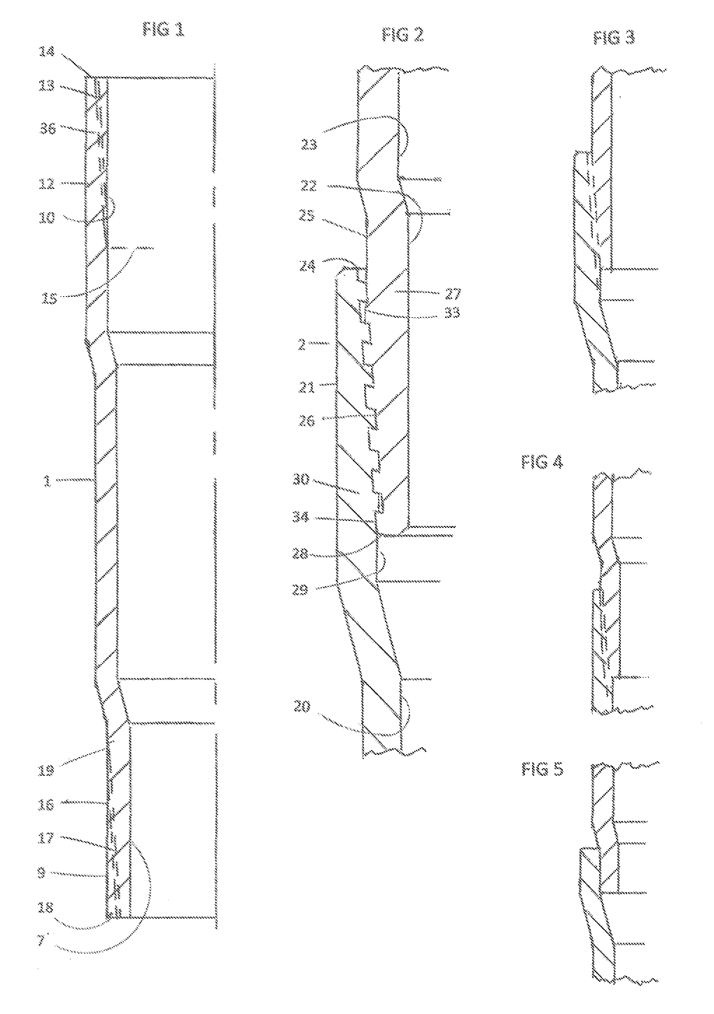

In FIG. 2, ends of two finished pipe-joints as depicted in FIG. 1, are shown assembled to form connection (2), having box OD (21) larger than the pipe OD, and pin ID (22) smaller in diameter than the pipe ID's (20,23), but sufficient for the service intended. The smaller that pin ID (22) is dimensioned, the smaller the full strength box OD can be. After the pin ID is known, the pin OD may be calculated because the pin cross-section area substantially equals the pipe cross section area. Box thread root diameter (24) at box face, is preferably larger than pin OD (25) by twice radial thread depth (26) so as to fully engage pin run-out threads (33) and thereby develop full strength of pin neck (27). After the thread form is selected, the thread length may be calculated, as the length required for the engaged flank area to substantially equal the pipe body cross section area. Then ideally, the box thread root diameter at face, minus the (required thread length multiplied by the thread taper) equals the box ID (29). The box OD may then be found because the box cross section area equals the pipe body cross section area. Thus, a full strength connection may be provided that requires machining only the faces and threads of the box and pin.

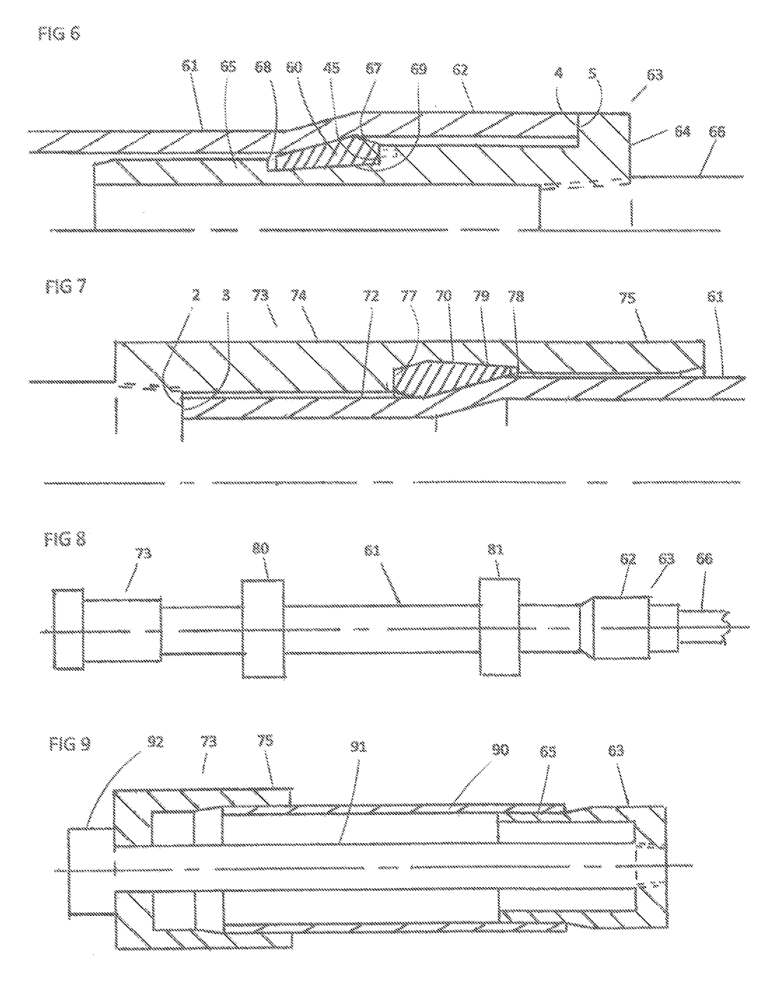

Ideally, pin root diameter (28) at face, is smaller than box ID (29) by twice thread depth (26) to engage box run-out threads (34) and thereby provide full strength for box neck (30). For API casing and tubing pipe sizes, the pin OD may be reduced to be 97.5% of the nominal pipe OD so the pin ID will be slightly larger than the pipe drift diameter. For other services such as for drill pipe, the pin ID may be reduced in accord with particular service requirements. For other services, the box end may be expanded to be larger as in FIG. 3 and the pin end may be threaded without forming, if pipe mill tolerances are acceptable for the intended service. Conversely, should external clearance be most important and a smaller ID is permissible for a given service, then the pin end may be further reduced and the box end threaded within the pipe with no forming as shown in FIG. 4, or the box OD and pin ID may be sized between those shown in FIG. 3 and FIG. 4. A slip-weld connection shown in FIG. 5 may be also be made by this method.

FIG. 6 illustrates a box expansion ring (60) at the end of its stroke after expanding an end-length of pipe joint (61) to form box (62), the ring being a component of expansion module (63) that comprises frame (64) and nose (65), all being mounted on ramrod (66) that positions the module with respect to the pipe end and also transmits and axial force to the module. Shoulder (67) of the frame acts against the ring to force it into the pipe, and shoulder (68) retracts the ring on the return stroke. Taper (69) of the module forces the ring out against the pipe to the desired diameter during the power stroke and then on the return stroke, allows it to contract radially to minimize force against the pipe after a short relative movement between ring and frame occurs during the return stroke, to save power and to save wear on the ring. Nose (65) guides the module into position with the pipe end prior to the power stroke and frame shoulder (4) abuts pipe-end (5) to stop the power stroke after the desired box length is formed. Set screws (45) may project from ring shoulder (67) so as to stop the ring at a chosen diameter along the taper before it reaches shoulder (67), to thereby expand the box contour ID to specific smaller ID's required for pipes having thicker walls.

FIG. 7 shows reducing ring (70) at the end of its power stoke after reducing an end of pipe joint (61) to form pin contour (72), the ring being a component of reducing module (73), that comprises frame (74) and nose (75), the module being adjustably fixed so as to position the module relative to the pipe and also hold it against force from the box end. Shoulder (77) of the frame acts against the ring to force it around the pipe end-length to reduce it in diameter and shoulder (78) retracts the ring on the return stroke. Taper (79) of the module forces the ring toward the pipe during the power stroke, and allows it to fall away from the pipe during the return stroke to save power and to save wear on the ring. Pipe-end (2) abuts shoulder (3) to limit the length of pipe reduced to form the pin, the ram movement being limited when a preset force or stroke length is reached. Nose (75) is dimensioned to guide the module around the pipe-end prior to the power stroke and when the module is used in the field and the nose also supports weight of the module. Set screws may be provided to adjust pin OD size as described above, however, the pin OD for a given size and type connection is preferably constant, to insure thread interchangeability between threads on like size pipes having different wall thicknesses.

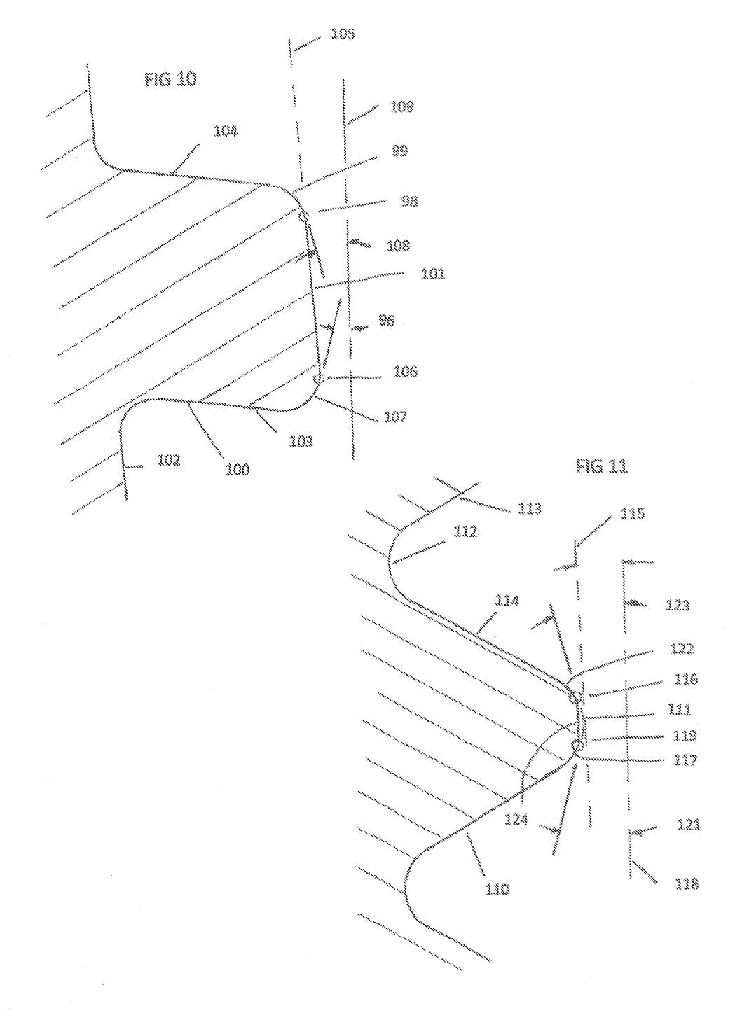

FIG. 8 is an overhead view of pipe joint (61) positioned and supported by power rollers (80) and (81) between the box module (63) and the pin module (73) such that force from ramrod (66) is transmitted through module (63) to expand box OD (62), the ram force being transmitted axially through pipe joint (61) to act against the module (63) and thereby reduce the diameter of pipe end-length to form pin OD, both pipe ends being formed in only one positioning of the pipe and one power stroke.

FIG. 9 depicts use of the modules in the field to form ends of pipe joint (90), nose (65) of module (63) being pushed into one pipe-end ready to form the box, and nose (75) of module (73) being pushed around the other pipe-end ready to form the pin, both modules being held in position and supported by the pipe, the pipe joint perhaps being one of many joints stacked in layers in a pipe storage yard. Modules too heavy to lift by hand may be lifted by such as lift-trucks that stack the pipe. The modules may be powered to form the pipe-ends as by any suitable means as by device (92), using such as tension member (91) that extends axially through the pipe between modules, to pull the modules together against both ends of the pipe-joint as explained above. Tension member (91) is depicted as a threaded pipe and device (92) is depicted as a hydraulic piston but any suitable device may be employed. Thus, pipe ends may be formed anytime before they are to be threaded without moving them to and from storage, which reduces handling costs in addition to the elimination of costs to form each pipe-end separately or in large machines.

FIG. 10 depicts a buttress type thread form (100), having tapered crest (101), root (102), load flank (103), stab flank (104) and thread taper reference line (105) positioned along the crests. Load flank crest arc (107) extends from the load flank to point (106) on crest (101) such that no portion of arc (107) forms an angle (96) with the axis that is less than the critical angle. Stab flank crest arc (99) extends from the stab flank to the crest as at point (98), such that no portion of arc (99) forms an angle (108) with the axis that is less than the critical angle.

FIG. 11 depicts a pipe thread form (110) such as an API 5B 8Round form, having round crest (111), round root (112), load flank (113), stab flank (114) and thread taper reference line (115) which is tangent to the crests before modifications taught by the present invention. Load crest arc (117) extends from the load flank to juncture point (119) on the crest, forming angle (121) between the arc and the axis (118), angle (121) being no less than the critical angle, and stab crest arc (122) extends from the stab flank to juncture point (116) on the crest, forming angle (123) between the arc and the axis (118), angle (123) being no less than the critical angle. The resulting crest (124) may then be a straight line parallel with the axis.

Thus, regardless of the relative rotational position of the pin and box when stabbed, the threads cannot contact at an angle less than the critical angle and thereby not cause damage to each other. To practice the invention with some thread forms, it may be necessary to so modify only the pin or box threads, or both, or only one flank may be modified, depending on the thread form. If the threads are intended to seal against extremely high pressure gas or dangerous chemicals, then the mating roots may require added material in the thread form to prevent unacceptable gaps between the mating threads. The crests may comprise constant or variable radii, or angles, without departing from the spirit of my invention. Thus, when the pin is stabbed into the box or lifted there from, the pin crests will pass the box crests without damaging each other regardless of their relative rotational position, and reverse rotation of the pin to avert improper makeup is moot, which will save costly rig time and more importantly, to prevent extremely costly down hole problems.

I claim:

1. A method of forming ends of a pipe-joint (61), comprising:
Forming both ends with use of the same axial force.

2. The method of claim 1, further comprising:
The axial force being transmitted compressively through the pipe-joint being formed.

3. The method of claim 2, having a tension member (91), further comprising:
The compressive axial force resulting from a tensile force transmitted to the pipe ends via a tension member positioned within the pipe-joint being formed.

4. A method for forming ends of a pipe joint (61), using a box module (63) to form a contour for a box (62), the box module having a nose (65); and a pin module (73) to form a contour for a pin (72), the pin module having a nose (75), comprising:
The box module being designed for mounting with an end of the pipe joint to expand a predetermined length of the joint to form the box contour;
The pin module being designed for mounting with the other end of the pipe joint to reduce a pre-determined length of the pipe end to form the pin contour;
The box module nose being formed to position and support the box module relative to the pipe end;
The pin module nose being formed to position and support the pin module relative to the other pipe end;
Forcing the modules against the pipe ends sufficiently to form the pipe ends to have predetermined contours.

5. The method of claim 4, further comprising:
The noses being configured and sized so as to apply weight of the modules on the pipe to support the modules in position to form the ends.

6. The method of claim 4 having a box expansion ring (60) and a pin reducing ring (70), further comprising:
The expansion ring being sized and mounted in position to expand a pre-determined end-length of the pipe joint to form the box contour to the desired ID;
The reducing ring being sized and mounted in position to reduce a pre-determined end-length of the pipe joint to form the pin contour to the desired OD.

7. The method of claim 6 further comprising:
The expansion ring and the reducing ring being mounted and held in their respective sizing positions against the pipe during the sizing stroke and relieved from high pressure contact with the pipe during their return strokes.

8. A pipe connection contour formed by a method of claims 1-7.

9. A pipe joint (1) having a pin contour formed on an end of the joint, the pin contour having an OD (9), a pin neck (35), an ID (7) sufficient for the intended service, a pin face (18) and a pin thread (17) to be formed on the pin contour OD, comprising:
The pin neck having a cross section area substantially equal to the cross section area of the pipe.

10. The pipe joint of claim 9, having a pin thread run out diameter (19) further comprising:
The pin thread to be formed, being dimensioned to have a maximum run out diameter substantially equal to the OD of the pin contour.

11. The pipe joint of claim 9, wherein the pin thread (17) to be formed, has a thread length (19) and a load flank area (36) for engagement with mating box threads (13), further comprising:
The flank area being substantially equal to the cross section area of the pipe body.

12. The pipe joint of claim 9 having a pin face (18) and a pin OD (16) further comprising:
The pin thread to be formed, to extend from the pin face to the pin OD.

13. The pipe joint of claim 11 having a box OD (12) formed on the other end of the pipe joint, the box contour having an ID (10), a box face (14) and a box thread (13) to be formed within the box contour ID for mating engagement with a pin thread, further comprising:
The box contour having a cross section area substantially equal to the pipe body cross section area; the maximum crest diameter of the box thread to be later formed, being dimensioned substantially equal to the pin contour OD.

14. The pipe joint of claim 13, wherein the box thread to be formed has a load flank area (36) for engagement with mating pin thread further comprising:
The load flank area being substantially equal to the cross section area of the pipe body.

15. The pipe joint of claim 14, further comprising:
The box thread to be formed being dimensioned from the box face to the box ID.

16. The pipe joint of claim 14, having a thread depth (26) further comprising:
The box ID being substantially equal to, the pin OD plus twice the thread depth, minus the thread length multiplied by the taper.

17. The pipe joint of claims 9-16, further comprising:
The pipe thread being formed on a taper not less than 0.08 nor more than 0.24.

18. The pipe joint of claims 9-16, further comprising:
The pipe thread being formed on a 0.14 taper.

19. A thread form (100) for a tapered pipe thread having a thread axis (109), a load flank (103), a load flank crest arc (107), a thread taper line (105) positioned along the crest (101) of each thread turn a juncture point (106) between the crest and the crest arc, and guide angle (96) formed between the arc and the axis, comprising:
The load flank crest arc extending from the load flank to the crest at the juncture point such that guide angle formed between the axis and the arc is not less than the critical angle.

20. A thread form (100) for a tapered pipe thread having a thread axis (109), a stab flank (104), a stab flank crest arc (99), a thread taper line (105) positioned along the crest (101) of the thread, a juncture point (98) between the crest and the crest arc, and guide angle (108) formed between the arc and the axis, comprising:
The stab flank crest arc extending from the stab flank to the crest such that the angle formed between the axis and the arc is not less than the critical angle.

21. The thread form of claim 19 or claim 20, further comprising:
The mating surfaces of the mating threads opposite the juncture points, being formed complimentary to the crests so as to prevent gaps that may cause leakage between the mating threads when assembled.

22. The thread form of claim 19 or claim 20, further comprising:
The crest arcs being replaced by suitable angular surfaces that form a guide angle with the axis that is not less than the critical angle.

23. A method for forming ends of a pipe joint (61), using a box module (63) to form a contour for a box (62), the box module having a nose (65); and a pin module (73) to form a contour for a pin (72), the pin module having a nose (75), the pin contour and the box contour being formed with mating threads (17,13) the threads having guide angles (96,108) comprising:
The box module being designed for mounting with an end of the pipe joint to expand a predetermined length of the joint to form the box contour;
The pin module being designed for mounting with the other end of the pipe joint to reduce a pre-determined length of the pipe end to form the pin contour;
The box module nose being formed to position and support the box module relative to the pipe end;
The pin module nose being formed to position and support the pin module relative to the other pipe end;
Forcing the modules against the pipe ends sufficiently to form the pipe ends to have predetermined contours;
And then forming threads on the box and pin contours that have guide angles not less than the critical angle.
